(19) United States
(12) Patent Application Publication
(10) Pub. No.: US 2004/0003375 A1
(43) Pub. Date: Jan. 1, 2004

(54) Method and system for combining dynamic instrumentation and instruction pointer sampling

(76) Inventors: Jini S. George, Bangalore (IN); Robert Hundt, Santa Clara, CA (US); Dave Babcock, San Jose, CA (US); Sujoy Saraswati, Bangalore (IN); Eric Gouriou, Sunnyvale, CA (US); Manoj N. P., Bangalore (IN); Umesh Krishnaswamy, Sunnyvale, CA (US)

Correspondence Address: HEWLETT-PACKARD COMPANY, Intellectual Property Administration, P.O. Box 272400, Fort Collins, CO, 80527-2400, US

(21) Appl. No.: 10/186,467

(22) Filed: Jun. 28, 2002

(51) Int. Cl. G06F 9/44

(52) U.S. Cl. 717/124

(57) ABSTRACT

A computer-implemented method for examining a software program using dynamic instrumentation and instruction pointer sampling. In one embodiment, the method includes the step of inserting probe code into a program during runtime. A performance analysis tool is used to collect data resulting from execution of the probe code. The performance analysis tool is also used to collect instruction pointer samples from the execution. The collected data and the instruction pointer samples are then combined.

### TECHNICAL FIELD

The present claimed invention relates to analysis of a computer program. More specifically, the present claimed invention relates to the runtime analyzing of application and library functions.

### BACKGROUND ART

Code instrumentation is a method for analyzing and evaluating program code performance. In one approach to code instrumentation, new instructions (or probe code) are added to the program, and, consequently, the original code in the program is changed and/or relocated. Some examples of probe code include adding values to a register, moving the content of one register to another register, moving the address of some data to some registers, etc. The changed and/or relocated code is referred to as instrumented code or, more generally, as an instrumented process. For purposes of the present discussion, instrumented code is one type of dynamically generated code. Although the following discussion explicitly recites and discusses code instrumentation, such discussion and examples are for illustration only. That is, the following discussion also applies to various other types of dynamically generated code.

One specific type of code instrumentation is referred to as dynamic binary instrumentation. Dynamic binary instrumentation allows program instructions to be changed on-the-fly. Measurements such as basic-block coverage and function invocation counting can be accurately determined using dynamic binary instrumentation. Additionally, dynamic binary instrumentation, as opposed to static instrumentation, is performed at runtime of a program and only instruments those parts of an executable that are actually executed. This minimizes the overhead imposed by the instrumentation process itself. Furthermore, performance analysis tools based on dynamic binary instrumentation require no special preparation of an executable such as, for example, a modified build or link process.

A typical prior art code instrumentation process implements dynamic instrumentation and analysis by compiling the source code of a target application (e.g., the application being analyzed) with a specific instrumentation option enabled. This option results in the application code being compiled and instrumented with probe code to facilitate analysis. When the resulting instrumented application code is executed, analysis data generated by the inserted probe code is collected in a file for later analysis. The analysis data is then examined and used to create reports depicting the execution flow of the application code.

The problem with this typical prior art instrumentation process is the fact that it is laborious and is not easily used in today's complicated build environment. The overhead of the prior art code instrumentation process is high since instrumentation takes place for all the functions (and not just the reached functions). Moreover, each shared library for which profile data is desired is required to be compiled with the specific instrumentation option enabled in order to be instrumented.

Additional problems with the prior art instrumentation process arise when “inlined” application code and “virtual” functions are encountered. As an explanation, many programming languages offer support for “inlining” functions. That is, many programming languages such as, for example, C++, allow the compiler to generate machine code for a function call such that the code from the function body gets directly inserted into the place where the call was made. Conventional performance analysis tools cannot properly correlate and account for inlined function information, and as such, can not properly analyze such code. With respect to virtual functions, certain modern programming languages such as, for example, C++ offer the ability to inherit so called derived objects from other base objects. These base and/or derived objects use what are known as virtual functions. In certain instances it is possible to make a call to a virtual function. To accomplish this, the compiler generates an array of function pointers, known as a virtual table, for each object type that contains at least one virtual function. During the virtual function call, this virtual table is indexed to obtain a function pointer, and then an indirect call is made using that function pointer. Such tables must be created because the actual function call made may not be determinable at compile time. Additionally, it is not possible, at present, to readily instrument or analyze such virtual function calls.

Other problems with the prior art instrumentation process arise from the fact that the sampling rate yielded by the probe code cannot be varied. This is problematic since there may be occasions when it is desirable to have an increased sampling rate to obtain a more detailed view of execution flow. Instruction pointer sampling refers to the fact that while the application runs, a tool samples its instruction pointer periodically, and records the value of the instruction pointer each time it takes a sample. The resulting data is tabulated and written to a specified file for later analysis. It is problematic that control over the rate at which sample data is collected is not available to the user.

Therefore, clearly there is a need for a better approach to dynamic code instrumentation and analysis.

### DISCLOSURE OF THE INVENTION

The present invention provides a method and system for combining dynamic instrumentation and instruction pointer sampling to examine a software program.

Specifically, in one method embodiment, the present invention inserts probe code into a program during runtime. A performance analysis tool is used to collect data resulting from execution of the probe code. The performance analysis tool is also used to collect instruction pointer samples from the execution. The collected data and the instruction pointer samples are then combined.

These and other technical advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a schematic diagram of an exemplary computer system used to perform steps of the present method in accordance with various embodiments of the present claimed invention.

FIG. 2 is a flow chart of steps performed to analyze a target application function in accordance with one embodiment of the present claimed invention.

FIG. 3 is a flow chart of steps performed to analyze a target application including the step of creating a profile report in accordance with one embodiment of the present claimed invention.

FIG. 4 is a diagram of a portion of an example callgraph in accordance with one embodiment of the present invention.

The drawings referred to in this description should be understood as not being drawn to scale except if specifically noted.

### BEST MODES FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining”, “instrumenting”, “overwriting”, “executing”, “performing”, or the like, refer to the actions and processes of a computer system, or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present invention is also well suited to the use of other computer systems such as, for example, optical and mechanical computers.

### Computer System Environment of the Present Invention

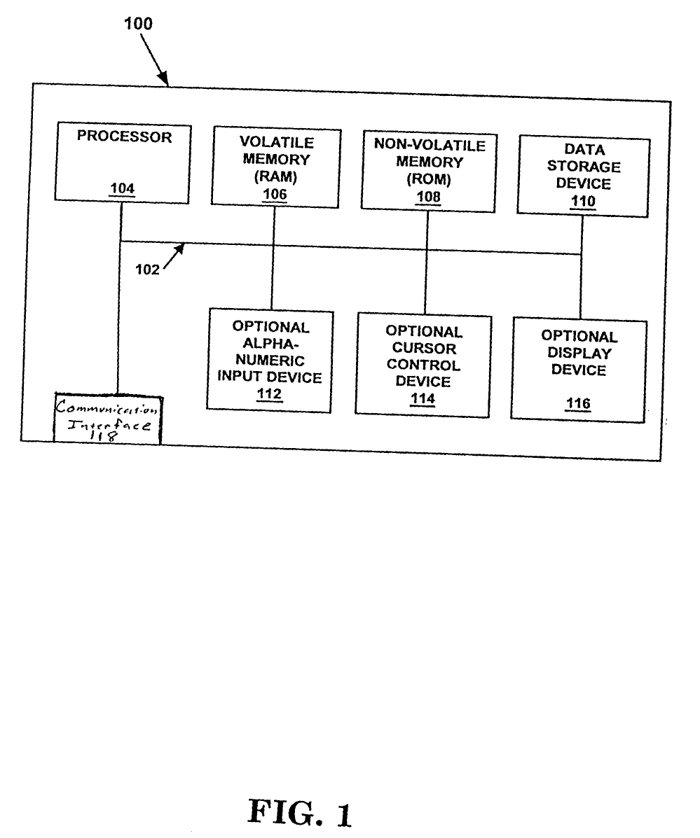

With reference now to FIG. 1, portions of the present method and system are comprised of computer-readable and computer-executable instructions which reside, for example, in computer-usable media of a computer system. FIG. 1 illustrates an exemplary computer system 100 used in accordance with one embodiment of the present invention. It is appreciated that system 100 of FIG. 1 is exemplary only and that the present invention can operate on or within a number of different computer systems including general purpose networked computer systems, embedded computer systems, routers, switches, server devices, client devices, various intermediate devices/nodes, stand alone computer systems, and the like. Additionally, computer system 100 of FIG. 1 is well adapted having computer readable media such as, for example, a floppy disk, a compact disc, and the like coupled thereto. Such computer readable media is not shown coupled to computer system 100 in FIG. 1 for purposes of clarity. Additionally, portions of the present embodiment are well suited to operating in conjunction with various mobile clients such as, for example, a cell phone, personal digital assistant (PDA), laptop computer, pager, and the like.

System 100 of FIG. 1 includes an address/data bus 102 for communicating information, and a central processor unit 104 coupled to bus 102 for processing information and instructions. As an example, central processor unit 104 may be an IA-64 microprocessor architecture by Intel Corporation of Santa Clara, Calif. System 100 also includes data storage features such as a computer usable volatile memory 106, e.g. random access memory (RAM), coupled to bus 102 for storing information and instructions for central processor unit 104. System 100 also includes computer usable non-volatile memory 108, e.g. read only memory (ROM), coupled to bus 102 for storing static information and instructions for the central processor unit 104. Such static information is comprised, in one embodiment, of commands for configuration and initial operations of computer system 100. Computer system 100 also includes a data storage unit 110 (e.g., a magnetic or optical disk and disk drive) coupled to bus 102 for storing information and instructions.

System 100 of the present invention also includes an optional alphanumeric input device 112 including alphanumeric and function keys coupled to bus 102 for communicating information and command selections to central processor unit 104. System 100 also optionally includes an optional cursor control device 114 coupled to bus 102 for communicating user input information and command selections to central processor unit 104. System 100 of the present embodiment also includes an optional display device 116 coupled to bus 102 for displaying information. System 100 of the present embodiment also includes a communication interface 118 which enables computer system 100 to interface with other computers or devices. In one embodiment, communication 118 is, for example, a modem, an integrated services digital network (ISDN) card or the like, a local area network (LAN) port, etc. Those skilled in the art will recognize that modems or various types of network interface cards (NICs) typically provide data communications via telephone lines, while a LAN port provides data communications via a LAN. Communication interface 118 of computer system 100 may also enable wireless communications. Furthermore, communication interface 118 may enable communication with other computers or devices through one or more networks. For example, computer system 100, using communication interface 118, may communicate to the “Internet.”

Computer system 100 may be used to implement the techniques described below. In various embodiments, processor 104 performs the steps of the techniques by executing instructions brought to RAM 106. In alternative embodiments, hard-wired circuitry may be used in place of or in combination with software instructions to implement the described techniques. Consequently, embodiments of the invention are not limited to any one or a combination of software, hardware, or circuitry.

Instructions executed by processor 104 may be stored in and carried through one or more computer-readable media, which refer to any medium from which a computer reads information. Computer-readable media may be, for example, a floppy disk, a hard disk, a zip-drive cartridge, a magnetic tape, or any other magnetic medium, a CD-ROM, a CD-RAM, a DVD-ROM, a DVD-RAM, or any other optical medium, paper-tape, punch-cards, or any other physical medium having patterns of holes, a RAM, a ROM, an EPROM, or any other memory chip or cartridge. Computer-readable media may also be coaxial cables, copper wire, fiber optics, acoustic, or light waves, etc. As an example, the instructions to be executed by processor 104 are in the form of one or more software programs and are initially stored in a CD-ROM being interfaced with computer system 100. Computer system 100 loads these instructions in RAM 106, executes some instructions, and sends some instructions via communication interface 118, a modem, and a telephone line to a network, the Internet, etc. A remote computer, receiving data through a network cable, executes the received instructions and sends the data to computer system 100 to be stored in storage device 110.

Referring still to FIG. 1, optional display device 116 of FIG. 1, may be a liquid crystal device, cathode ray tube, or other display device suitable for creating graphic images and alphanumeric characters recognizable to a user. Optional cursor control device 114 allows the computer user to dynamically signal the two dimensional movement of a visible symbol (cursor) on a display screen of display device 116. Many implementations of cursor control device 114 are known in the art including a trackball, mouse, touch pad, joystick or special keys on alphanumeric input device 112 capable of signaling movement of a given direction or manner of displacement. Alternatively, it will be appreciated that a cursor can be directed and/or activated via input from alphanumeric input device 112 using special keys and key sequence commands. The present invention is also well suited to directing a cursor by other means such as, for example, voice commands. A more detailed discussion of the present invention is found below.

### General Method and System for Combining Dynamic Instrumentation and Instruction Pointer Sampling to Examine a Software Program

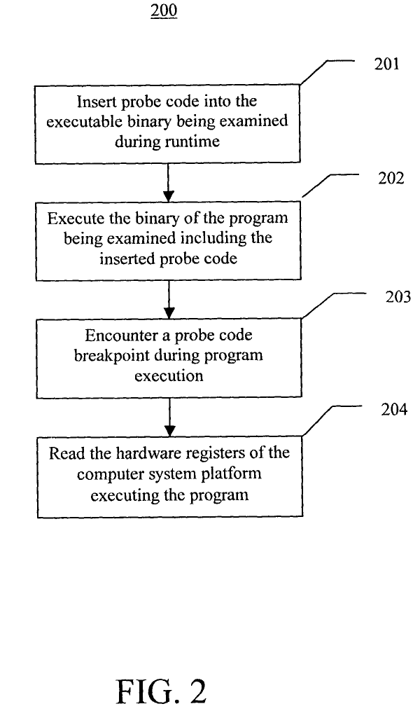

With reference next to flow chart 200 of FIG. 2 and to FIG. 1, exemplary steps used by the various embodiments of present invention are illustrated. Flow chart 200 includes processes of the present invention which, in one embodiment, are carried out by a processor under the control of computer-readable and computer-executable instructions. The computer-readable and computer-executable instructions reside, for example, in data storage features such as computer usable volatile memory 106, computer usable non-volatile memory 108, and/or data storage device 110 of FIG. 1. In one embodiment, the computer-readable and computer-executable instructions are used to control or operate in conjunction with, for example, processor 104 of FIG. 1.

With reference again to FIG. 2, steps performed in accordance with one embodiment of the present invention are shown. Although specific steps are disclosed in flow chart 200 of FIG. 2, such steps are exemplary. That is, the present invention is well suited to performing various other steps or variations of the steps recited in FIG. 2. In one embodiment, the present invention inserts probe code into a program during runtime. The present embodiment uses a performance analysis tool to collect data resulting from execution of the probe code. The present embodiment also uses the performance analysis tool to collect instruction pointer samples from execution of the program. Specifically, the data is used to generate a report based on a combination of dynamic instrumentation and IP (Instruction Pointer) sampling. Embodiments of the present invention described here are not specific to any particular architecture, however, example implementations are described in the context of a UNIX operating environment (e.g., HP-UX) running on 64-bit microprocessor computer systems (e.g., running on IA-64 Itanium™/Itanium2™ processors).

Embodiments of present invention are configured to generate reports comprising two parts. Depending upon the particular requirements of a given embodiment, a first part shows a flat profile that gives the sorted total execution times and call counts for the reached functions in the program being examined. A second part shows a callgraph that has entries for functions sorted according to the total time of their descendants and themselves. For example, entries in the callgraph are accompanied by data showing the number of times each of its parents called a particular function and the number of times it called each of its children.

Referring now to step 201, the present embodiment inserts probe code into the executable binary of the program being examined during runtime. Probe code can be considered to be a sequence of instructions to collect different metrics of the target application (e.g., the program being examined). Embodiments of the present invention insert the probe code dynamically in order to limit the resulting instrumentation only to the part of the code executed. This aspect also eliminates the need for any special compilation flag to enable profiling of a target application, thereby eliminating a need to recompile the target application in order to accomplish the profiling. This aspect also leads to the fact that the shared libraries will also get automatically profiled.

In one embodiment, IP sampling is accomplished using a performance measuring unit (PMU) of the Itanium™ or Itanium2™ processor architecture. In such an embodiment, IP sampling can be implemented at regular, user selectable, intervals during execution of the program. Generally, however, it should be noted that embodiments of the present invention are suited for other methods of reading hardware registers of a computer system to collect data regarding the hardware registers (e.g., instruction pointer data, etc.) in addition to using the PMU.

Referring now to step 202, the present embodiment executes the binary of the program being examined, including the inserted probe code. In one embodiment, the inserted probe code comprises breakpoints inserted at the function entry points of the various functions of the program.

In step 203, process 200, during the execution of the program being examined, hits a breakpoint from the inserted probe code. The breakpoint is encountered as, for example, one of the functions of the program is being executed. In the present embodiment, when the program execution hits the breakpoint, control is transferred back to a profiling program (e.g., HP Caliper™) which then proceeds to dynamically instrument that function. The instrumented function is written into shared memory that is shared by both a profiling program in accordance with one embodiment of the present invention and the application being profiled. The break at the beginning of the function is patched with a long branch to this instrumented portion of code in the shared memory. In the present embodiment, when instrumentation of the function is complete, the execution of the program is resumed at the first instruction of the instrumented function. Additional details related to instrumentation including discussion of features such as breakpoints can be found in co-owned, commonly-assigned U.S. patent application Ser. No. 09/833,248 filed Apr. 11, 2001, entitled “Dynamic Instrumentation Of An Executable Program”, to Hundt et al. which is incorporated herein by reference as background material.

In step 204, the hardware registers of the computer system platform executing the program are read. In one embodiment, the PMU (e.g., of the IA-64 family of processors) of the processor is used to monitor and collect register data, leveraging the support provided by the kernel to program and read the hardware performance registers. In this embodiment, a perfmon( ) system call is used as an interface to program and to read the hardware counter-registers on behalf of the program being examined. Additionally, in one embodiment, the data is collected and used to build a callgraph in a single step procedure, unlike the approach used in standard UNIX callgraph profiling methods (e.g., “gprof”).

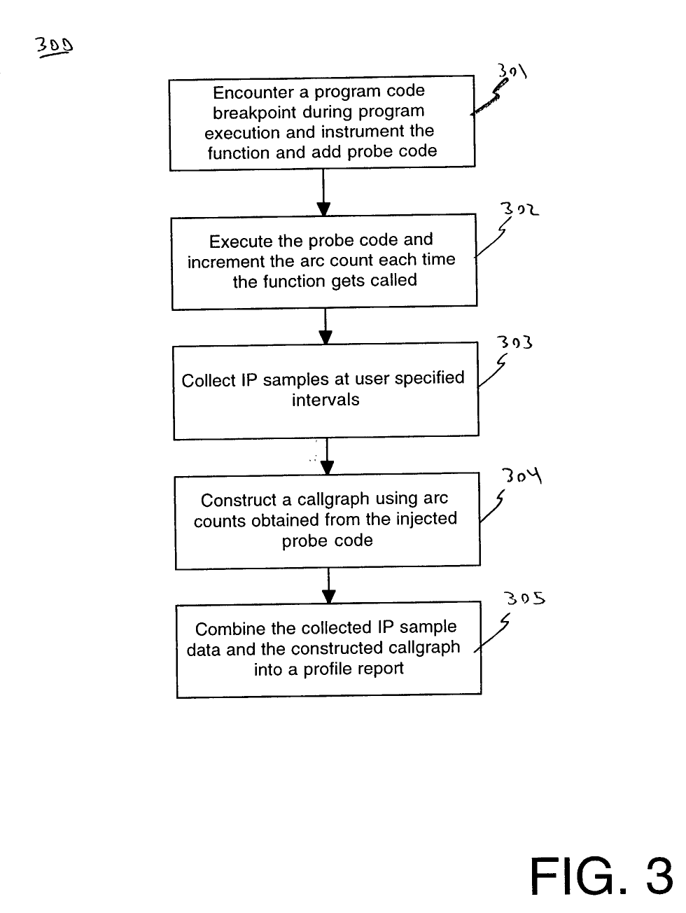

With reference now to FIG. 3, a flow chart 300 of steps performed in accordance with another embodiment of the present invention is shown. In step 301, during the execution of the program being examined, a breakpoint is encountered. The breakpoint is encountered as, for example, one of the functions of the program is being executed. Upon encountering the breakpoint, the function is instrumented and probe code is added.

In step 302, the probe code is executed and an arc count is incremented each time the function is called. In the present embodiment, the probe code inserted into the instrumented function increments the arc count each time the function gets called. In one embodiment, if the target application falls in a different load module as compared to the source, the target address would be the starting address of an “import stub”. As used herein, “import stubs” are pieces of code that, with the help of a dynamic loader, help to find the final target of an intermodular call. In the present embodiment, special processing of the import stubs and reading the PLT (procedure linkage table) entries is required in order to get the target address of the intended function in the called load module instead of the “import stub”.

In step 303, in the present embodiment, IP samples are collected at user specified intervals. In one embodiment, since dynamic instrumentation is used to count the arcs, most of the IP samples obtained would be instrumented samples from shared memory. These samples need to be mapped back to the original code. In one embodiment, the mapping back of these samples during the execution of the target application would result in a possible loss of samples. For example, this could be caused by PMU internal buffers being filled with samples such that further samples would be lost if processing the previous buffer is not completed and the buffer not released back to PMU. Moreover, even for a moderate sampling rate, the number of samples obtained from the PMU could be quite huge and could consume a large amount of memory for a long running target application. Hence, embodiments of the present invention buffer these instrumented samples using a fast bucketzing algorithm during the execution period of the target application executable. In one embodiment, the instrumented samples are mapped back to the bucket corresponding to the first bundle address of the original address space of the function after the exit of the profiled program.

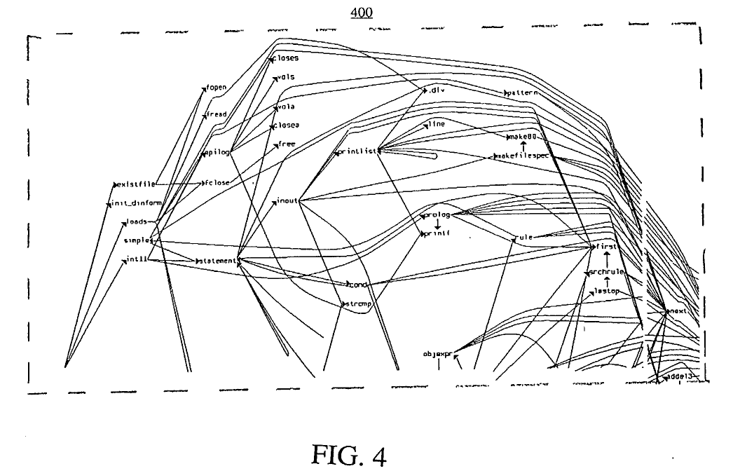

In step 304, the present embodiment constructs a callgraph using “arc counts” obtained from the injected probe code. In one embodiment, these “arc counts” consist of a source address, a target address and a count representing the number of times this arc was executed. Those arcs for which the target addresses form function entry points are considered. These types of arcs, for example, are referred to as call arcs. An example callgraph is shown in FIG. 4 below.

In step 305, the collected IP sample data and the constructed callgraph are combined into a profile report describing the execution profile of the target application. In the present embodiment, the IP samples obtained are used to list the function names in, for example, decreasing order of the number of IP samples found in them. Additionally, the callgraph shows the number of calls made to each function by counting the incoming arcs. In one embodiment, for the callgraph portion, the source and the target addresses of arcs are used to build a call chain of functions. The IP samples are used to propagate the execution time along the call chain of the functions.

Referring now to FIG. 4, an example of a portion of a callgraph 400 in accordance with one embodiment of the present invention is shown. Callgraph 400 shows a simple example of a callgraph used to keep track of functions and the calling relations between them (e.g., the lines between the function names). As known by those skilled in the art, callgraphs utilize filters which can be configured to show all function calls in the program, show only those function calls which have been called at least some minimum number of times, show calls to library routines, or other options.

In this manner, embodiments of the present invention provide a number of advantages with respect to the prior art. For example, embodiments of the present invention to not require the executable of the target application be recompiled with a special compiler flag to enable profiling. Since embodiments of the present invention utilize dynamic instrumentation, instrumentation is done for only those portions of the program that actually execute. Similarly, embodiments of the present invention also eliminate the need to recompile the shared libraries to be profiled. Additionally, embodiments of the present invention display profile and callgraph data for inlined and virtual functions. Moreover, embodiments of the present invention allow the sampling rate to be varied. Profile and callgraph data is displayed for applications that fork and execute, and profile reports are created with accompanying source correlation information. Additionally, the target application is profiled regardless of the presence of any “inlined” application code or “virtual” functions.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A computer-implemented method for examining a software program using dynamic instrumentation and instruction pointer sampling, said method comprising:
inserting probe code into a program during runtime;
using a performance analysis tool to collect data resulting from execution of said probe code;
using said performance analysis tool to collect instruction pointer samples from said execution; and
combining said collected data and said instruction pointer samples.

2. The computer implemented method for examining a software program using dynamic instrumentation and instruction pointer sampling as recited claim 1 further comprising:
inserting said probe code dynamically such that instrumentation is inserted into an executing portion of said program.

3. The computer implemented method for examining a software program using dynamic instrumentation and instruction pointer sampling as recited claim 1 further comprising:
inserting said probe code dynamically such that instrumentation is not inserted into a non-executing portion of said program.

4. The computer implemented method for examining a software program using dynamic instrumentation and instruction pointer sampling as recited claim 1 further comprising:
inserting a plurality of breakpoints at a corresponding plurality of function entry points of said software program; and
dynamically instrumenting at least one function of said software program when one of said plurality of function entry points is encountered during execution of said program.

5. The computer implemented method for examining a software program using dynamic instrumentation and instruction pointer sampling as recited claim 4 further comprising:
reading hardware registers of a computer system executing said program to collect data regarding said hardware registers when a buffer full notification is received from a kernel.

6. The computer implemented method for examining a software program using dynamic instrumentation and instruction pointer sampling as recited claim 5 further comprising:
buffering said instruction pointer samples using a fast bucketizing algorithm during execution of said program.

7. The computer implemented method for examining a software program using dynamic instrumentation and instruction pointer sampling as recited claim 1 further comprising:
generating an arc count using said collect data; and
constructing a callgraph using said arc count to characterize a plurality of calls of said program.

8. A computer-readable medium embodying instructions that cause a computer to perform method for examining a software program using dynamic instrumentation and instruction pointer sampling, said method comprising:
inserting probe code into a program during runtime;
using a performance analysis tool to collect data resulting from execution of said probe code;
using said performance analysis tool to collect instruction pointer samples from said execution; and
combining said collected data and said instruction pointer samples.

9. The computer-readable medium of claim 8 further comprising instructions that cause said computer to perform:
inserting said probe code dynamically such that instrumentation is inserted into an executing portion of said program.

10. The computer-readable medium of claim 8 further comprising instructions that cause said computer to perform:
inserting said probe code dynamically such that instrumentation is not inserted into a non-executing portion of said program.

11. The computer-readable medium of claim 8 further comprising instructions that cause said computer to perform:
inserting a plurality of breakpoints at a corresponding plurality of function entry points of said software program; and
dynamically instrumenting at least one function of said software program when one of said plurality of function entry points is encountered during execution of said program.

12. The computer-readable medium of claim 11 further comprising instructions that cause said computer to perform:
reading hardware registers of a computer system executing said program to collect data regarding said hardware registers when a buffer full notification is received from a kernel.

13. The computer-readable medium of claim 12 further comprising instructions that cause said computer to perform:
buffering said instruction pointer samples using a fast bucketizing algorithm during execution of said program.

14. The computer-readable medium of claim 12 further comprising instructions that cause said computer to perform:
generating an arc count using said collect data; and
constructing a callgraph using said arc count to characterize a plurality of calls of said program.

15. An apparatus for examining a software program using dynamic instrumentation and instruction pointer sampling, said method comprising:
means for inserting probe code into a program during runtime;
means for using a performance analysis tool to collect data resulting from execution of said probe code;
means for using said performance analysis tool to collect instruction pointer samples from said execution; and
means for combining said collected data and said instruction pointer samples.

16. The apparatus of claim 15 further comprising:
means for inserting said probe code dynamically such that instrumentation is inserted into an executing portion of said program.

17. The apparatus for claim 15 further comprising:
means for inserting said probe code dynamically such that instrumentation is not inserted into a non-executing portion of said program.

18. The apparatus of claim 15 further comprising:
means for inserting a plurality of breakpoints at a corresponding plurality of function entry points of said software program; and
means for dynamically instrumenting at least one function of said software program when one of said plurality of function entry points is encountered during execution of said program.

19. The apparatus of claim 18 further comprising:
means for reading hardware registers of a computer system executing said program to collect data regarding said hardware registers when one of said plurality of function entry points is encountered during execution of said program.

20. The apparatus for claim 18 further comprising:
means for reading hardware registers of a computer system executing said program to collect said instruction pointer samples when one of said plurality of function entry points is encountered during execution of said program.

21. The apparatus of claim 20 further comprising:
means for buffering said instruction pointer samples using a fast bucketizing algorithm during execution of said program.

24. The apparatus for claim 17 further comprising:
means for generating an arc count using said collect data; and
means for constructing a callgraph using said arc count to characterize a plurality of calls of said program.
